(19) United States
(12) Patent Application Publication
(10) Pub. No.: US 2007/0140293 A1
(43) Pub. Date: Jun. 21, 2007

(54) RFCI mapping to support backward-compatible transcoder-free operation for UMTS

(76) Inventors: Anjana Agarwal, Wheaton, IL (US); John Matthew Gafrick, Naperville, IL (US); Maridi Raju Makaraju, Wheaton, IL (US); Jakob J. Neulist, West Chicago, IL (US); Charu Verma, Darien, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/305,064

(22) Filed: Dec. 16, 2005

(51) Int. Cl. H04L 12/28; H04J 3/22; H04J 3/16; H04L 12/56; H04Q 7/24

(52) U.S. Cl. 370/466; 370/401; 370/338

(57) ABSTRACT

A transcoder-free operation (TrFO) implementation is disclosed that provides backward-compatibility, or interworking between nodes supporting Iu UP version 1 and version 2. A media gateway (MGW) on the terminating side of a prospective call detects mismatching RFCI values between an originating and terminating side of a prospective call, such as may occur when an originating MGW supports Iu UP version 2 and a terminating Radio Network Controller (RNC) supports Iu UP version 1. The terminating MGW performs a mapping and translation function to convert RFCI values associated with Iu UP version 2 to those of version 1, or vice versa, so as to accommodate the terminating RNC supporting Iu UP version 1.

FIELD OF THE INVENTION

This invention relates generally to a transcoder-free operation (TrFO) implementation in a UMTS wireless communication system and, more particularly, to a TrFO implementation that permits backward-compatibility between nodes (e.g., interworking between nodes supporting IuUP version 1 and version 2).

### BACKGROUND OF THE INVENTION

UMTS (Universal Mobile Telecommunications Service) is a third-generation (3G) wireless communication technology that offers broadband, packet-based communication services for users having suitably equipped user equipment (UE) comprising, for example, cell phones, mobile computers or the like. For a call between an originating and terminating UE, the originating UE wirelessly communicates, via RF resources, with a radio network controller (RNC) residing, for example, at a serving base site. The RNC communicates via packet-based link (e.g., ATM), with an MSC Server and Media Gateway (MGW) associated with the originating location. Generally, the MSC Server operates in a control plane (i.e., exchanges control messages) to negotiate call set-up and the like, whereas the MGW operates on a user plane to route bearer traffic and some control messages between the RNC and the terminating location via a core network (e.g., an IP network). The terminating location similarly includes an RNC linked to a MGW controlled by an MSC Server. The terminating MGW receives bearer traffic via the core network and delivers it to the RNC, and the RNC sends the bearer traffic via a wireless link to the terminating UE. On both the originating and terminating sides, the link between the UE and RNC is known as a radio bearer link and the link between the RNC and the MGW is known as an Iu link. The link between MGWs on the originating and terminating sides is known as the CN (“core network”) link.

As is well known, transcoders (also known as vocoders or codecs) are used to compress speech in order to conserve bandwidth in the call path. In conventional “tandem” operation, speech is encoded at the originating UE, decoded at the originating MGW and transmitted over the CN link; on the terminating side, the speech is encoded at the terminating MGW and decoded at the terminating UE. This results in double encoding of speech, which can significantly degrade speech quality. It is desirable to avoid double encoding of speech if possible to improve speech quality. One case in which double encoding can be avoided is where the originating and terminating UE support compatible codec types and modes. In such case, the transcoders of the originating and terminating MGW are unnecessary and can be bypassed. This configuration is known as transcoder-free operation (TrFO).

Out-of-band transcoder control (OoBTC) is a mechanism by which the MSC servers negotiate the preferred codec type to be used between end nodes for a particular call and to attempt to establish TrFO. The MSC servers also initiate a framing protocol initialization to attempt to define the user plane (UP) protocol to be used between the RNCs and MGWs. Both codec negotiation and framing protocol initialization is accomplished prior to committing bearer resources between the end nodes. Presently, three conditions are necessary to establish TrFO. The first condition is that compatible codec types are used between end nodes. The second condition is that both the RNC and MGW use a UP protocol that supports TrFO, for example, “version 2” user plane protocol (Iu UP version 2) as specified in the “Release 4” UMTS standards. The third condition is that, during framing protocol initialization, matching “RFCI” values (Radio Access Bearer sub-flow Combination Indicator) must be used on the network side and the RNC side of the terminating MGW.

A problem that arises, however, is that there will be cases when the terminating RNC uses a UP protocol that does not support TrFO (or at least will not support TrFO if implemented according to present standards). For example, many RNCs support a “version 1” Iu UP protocol as specified in the baseline version “Release 99” UMTS standards. Iu UP version 1 protocol is not considered to support TrFO under present standards. A related problem is that if an RNC uses Iu UP version 1, mismatching RFCI values are likely to occur between the network side and RNC side of the terminating MGW, thereby preventing TrFO implementation. Consequently, if an MSC server encounters a terminating RNC that supports only version 1 it will cause a transcoder to be inserted at the MGW that is connected to the RNC.

Accordingly, there is a need for a TrFO implementation that allows for inconsistent user plane protocols and/or mismatching RFCI values between nodes. Advantageously, the TrFO implementation will provide for backward-compatibility (i.e., interworking) between nodes supporting IuUP version 1 and version 2.

### SUMMARY OF THE INVENTION

This need is addressed and a technical advance is achieved in the art by a feature that provides a backward-compatible TrFO implementation (i.e., interworking between nodes supporting Iu UP version 1 and version 2). This is achieved by the MGW performing a mapping and translation function to accommodate mismatching RFCI values on the RNC interface and network interface of a MGW. In such manner, TrFO may be supported with a terminating RNC using Iu UP version 1 and with mismatching RFCI values on the terminating side of a call.

In one embodiment, a network element (e.g., terminating MGW) operates to initialize a user plane protocol for a prospective call. The network element detects a mismatch between the user plane protocol initiated from an originating side and terminating side of the prospective call, the mismatch defining a first user plane protocol (e.g., Iu UP version 1) initiated from a terminating side node and a second user plane protocol (e.g., Iu UP version 2) initiated from a originating side node of the prospective call. In the prior art, such a protocol mismatch would prevent operation of TrFO. So as to provide TrFO, the network element translates control frames received from the terminating side node, characterizing the first user plane protocol, to control frames characterizing the second user plane protocol; and sends the control frames characterizing the second user plane protocol to the originating side node.

In another embodiment, there is provided a gateway element (e.g., terminating MGW) adapted for use in a communication network to convey packet data between an originating network node and a terminating network node. A first interface of the gateway element operates to exchange frames of packet data with the terminating network node characterizing a first user plane protocol (e.g., Iu UP version 1). A second interface of the gateway element operates to exchange frames of packet data with the originating network node characterizing a second user plane protocol (e.g., Iu UP version 2). The gateway element translates between frames characterizing one of said first and second user plane protocols to the other of said first and second user plane protocols so as to initiate TrFO.

### BRIEF DESCRIPTION OF THE DRAWINGS

The foregoing and other advantages of the invention will become apparent upon reading the following detailed description and upon reference to the drawings in which:

FIG. 1 is a block diagram showing the basic architecture of a UMTS system; and

FIG. 2 is a block diagram illustrating mapping and translation functions performed by a terminating MGW according to an embodiment of the invention.

### DESCRIPTION OF THE PREFERRED EMBODIMENT(S)

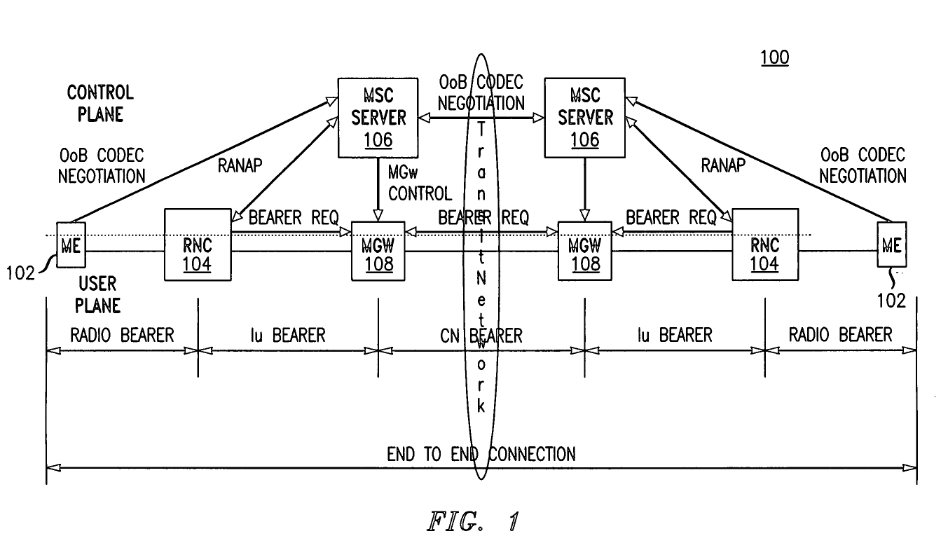

FIG. 1 depicts the basic architecture of a UMTS communication system 100 in which the present invention may be implemented. A plurality of UEs 102 (two shown) wirelessly communicates, via RF resources, with radio network controllers (RNC) 104 residing, for example, at serving base sites. For purposes of illustration, it is presumed one of the UEs 102 has initiated a call request directed to the other UE 102. The UE 102 having initiated the call request is known as the originating UE and the UE 102 to which the call is directed is known as the terminating UE. Either of the UEs 102 may initiate or terminate a call request. On both the originating and terminating sides of the call, the RNC 104 communicates via packet-based link (e.g., ATM), with an MSC Server 106 and Media Gateway (MGW) 108 associated with the RNC 104. The MSC Server 106 and MGW 108 are functional elements that may reside within a single device or multiple devices (residing, for example, within a Mobile Switching Center (MSC)).

The MSC Server 106 operates in a control plane to exchange control messages relating to call set-up, OoBTC codec negotiation, framing protocol initialization and the like. As shown, the control plane includes functional links between the MSC Server 106 and UE 102, RNC 104 and MGW 108 on both the originating and terminating sides and a link between the MSC Servers 106 on the originating and terminating sides of the prospective call. The functional links will not be described in detail herein; but are described in greater detail in 3GPP TS 23.153 V5.0.0 (2002-03), 3^{rd} Generation Partnership Project; Technical Specification Group Core Network; Out of Band Transcoder Control—Stage 2 (Release 5), incorporated herein by reference.

The MGW 108 operates on a user plane to communicate bearer traffic and some control traffic to and from the RNC. The link between the RNC 104 and MGW 108 is known as the Iu link (as shown, “Iu Bearer”) and the protocol used for communication over the Iu link is known as the Iu UP protocol. Payload and control information is communicated in frames of data, referred to as Protocol Data Units (PDUs). At call initialization (e.g., when negotiating TrFO), PDU frames comprise “type 14” control frames. The version of Iu UP protocol supported by the sending node is identified in a header and the RFCI values are identified in the payload of the PDU type 14 frames.

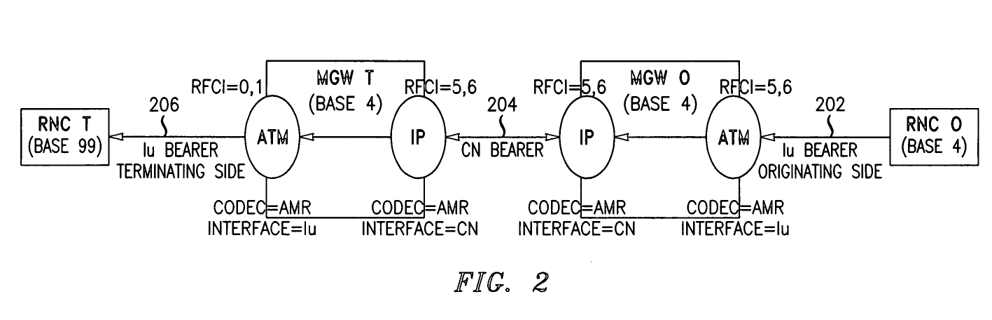

The MGW includes a processor and memory (not shown) for processing bearer traffic and control information communicated in the PDU frames as may be required. The MGW further includes codec resources (not shown) and is operable to use the codec resources to encode or decode the bearer traffic in conventional tandem operation or to bypass the codec to implement TrFO, where warranted. According to embodiments of the present invention, the MGW is operable to perform a mapping and translation function and change RFCI values communicated in the header of the PDU frames, where necessary, to enable interworking between nodes supporting Iu UP version 1 and version 2. The mapping and translation function of the MGW will be described in greater detail in relation to FIG. 2.

Generally, RFCI values are used to identify the bearer frames on the interface between the MGW and the RNC (i.e., the Iu interface) and also on the interface between MSCs (i.e., the CN interface) for OoBTC operation. The present OoBTC procedures mandate that these two RFCI streams be aligned (i.e., matching) and mandate an RNC upgrade to Iu UP version 2 to do so. Further, the core network is mandated to initialize the voice bearer to the RNC at certain stages; and base 99 RNCs do not support this type of initialization. According to embodiments of the present invention, the MGW performs RFCI mapping and translation functions so as to support TrFO operation with RNCs supporting Iu UP version 1.

An exemplary mapping and translation function to accommodate a version 1 RNC on the terminating side of a call may be observed in relation to FIG. 2. In FIG. 2, the notation “O” refers to the originating side and the notation “T” refers to the terminating side of a call. Accordingly, RNC O and MGW O refer to the originating RNC and MGW whereas RNC T and MGW T refer to the terminating RNC and MGW. It is presumed all transcoders in the communication path use compatible codec types (e.g., AMR). For purposes of the present example, it is presumed version 1 RNCs use RFCI values 0, 1 and version 2 RNCs and MGWs use RFCI values 5, 6; and hence the RFCI mapping function accommodates a mismatch between version 1 and version 2 RFCI values. As will be appreciated, however, version 1 and version 2 RFCI values may differ from the exemplary values.

FIG. 2 illustrates the case where the originating side RNC (“RNC O”) supports Iu UP version 2 and the terminating side RNC (“RNC T”) supports Iu UP version 1. The originating MGW (“MGW O”) and terminating MGW (“MGW T”) support Iu UP version 2.

At call origination, RNC O sends PDU type 14 frames over the originating Iu bearer channel 302 (as shown, an ATM link) to the originating MGW O. MGW O determines from the PDU type 14 frames the version of Iu UP protocol (i.e., Iu UP version 2) and the RFCI values (e.g., 5, 6) supported by RNC O. Coincident to the call origination, MGW O exchanges PDU type 14 frames over the CN bearer 304 (as shown, an IP link) with a terminating MGW (“MGW T”). MGW O determines from the PDU type 14 frames received from MGW T the version of Iu UP protocol (i.e., Iu UP version 2) and the RFCI values (e.g., 5, 6) supported by MGW T. MGW O recognizes that the RFCI values received from RNC O and MGW T are the same and hence, it does not need to perform a mapping and translation function convert the RFCI values. MGW O forwards the PDU type 14 frames with indicia of RFCI values 5, 6 and indicia of Iu UP version 2 over the CN bearer 304 (as shown, an IP link) to the terminating MGW (“MGW T”).

MGW T receives PDU type 14 frames over the Iu bearer 306 (as shown, an ATM link) from the terminating RNC (“RNC T”). MGW T determines from the PDU type 14 frames received from RNC T the version of Iu UP protocol (i.e., Iu UP version 1) and the RFCI values (e.g., 0, 1) supported by RNC T. MGW T recognizes the RFCI values received from RNC T and MGW O do not match and hence it performs a mapping function to convert the RFCI values 0, 1 to RFCI values 5, 6 before sending PDU type 14 control frames to MGW O. In one embodiment, this is accomplished by the MGW T removing indicia of RFCI values 0, 1 from the PDU type 14 packet header received from RNC T and replacing them with indicia of RFCI values 5, 6. MGW T also removes indicia of Iu UP version 1 from the PDU type 14 packet header and replaces it with indicia of Iu UP version 2. In such manner, MGW T produces a transformed PDU type 14 frame with indicia of RFCI values 5, 6 and indicia of Iu UP version 2. MGW T sends the transformed packets over the CN bearer 204 (as shown, an IP link) to the originating MGW (“MGW A”). Thus, PDU packets directed toward the terminating RNC will have RFCI values 0, 1 and those directed toward the network will have RFCI values 5, 6. In such manner, TrFO can be supported.

In one embodiment, the mapping and translation function described in relation to FIG. 2 is implemented using stored software routines and processing resources within the terminating MGW. As shown, MGW T includes an Iu interface operably connected to the RNC T via Iu Bearer 206; and a CN interface operably connected to MGW O via CN Bearer 204. MGW T exchanges frames of data between the RNC T and MGW O via the respective Iu and CN interfaces.

The present invention may be embodied in other specific forms without departing from its spirit or essential characteristics. For example, the mapping and translation function described herein is not limited to mapping between RFCI values associated with Iu UP version 1 and version 2 protocols may be utilized to map between any incompatible protocols or protocol versions and/or any mismatching RFCI values. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In a communication system including a network element operating to initialize a framing protocol for a prospective call, defining a user plane protocol, a method comprising the network element:
detecting a mismatch between the user plane protocol initiated from an originating side and terminating side of the prospective call, the mismatch defining a first user plane protocol initiated from a terminating side node and a second user plane protocol initiated from a originating side node of the prospective call;
translating control frames received from the terminating side node, characterizing the first user plane protocol, to control frames characterizing the second user plane protocol; and
sending the control frames characterizing the second user plane protocol to the originating side node.

2. The method of claim 1, wherein the network element comprises a media gateway (MGW) residing on a terminating side of the prospective call, defining a terminating MGW.

3. The method of claim 2, wherein the terminating MGW resides in a communication path between an originating MGW and a terminating radio network controller (RNC), the step of detecting a mismatch comprising detecting a first user plane protocol initiated by the terminating RNC and a second user plane protocol initiated by the originating MGW.

4. The method of claim 3, wherein the step of detecting a mismatch comprises detecting Iu UP version 1 protocol supported by the terminating RNC and Iu UP version 2 protocol supported by the originating MGW.

5. The method of claim 4 wherein the step of translating control frames comprises:
receiving, from the terminating RNC, a PDU type 14 control frame having indicia of Iu UP version 1 protocol;
replacing indicia of Iu UP version 1 protocol in the PDU type 14 control frame with indicia of Iu UP version 2 protocol, yielding a transformed PDU type 14 control frame compatible with the Iu UP version 2 protocol.

6. The method of claim 3, wherein the step of detecting a mismatch comprises detecting RFCI values associated with Iu UP version 1 protocol communicated from the terminating RNC and RFCI values associated with Iu UP version 2 protocol communicated from the originating MGW.

7. The method of claim 6 wherein the step of translating control frames comprises:
receiving, from the terminating RNC, a PDU type 14 control frame having RFCI values associated with Iu UP version 1 protocol;
replacing the RFCI values associated with Iu UP version 1 protocol in the PDU type 14 control frame with RFCI values associated with Iu UP version 2 protocol, yielding a transformed PDU type 14 control frame compatible with the Iu UP version 2 protocol.

8. A gateway element adapted for use in a communication network to convey packet data between an originating network node and a terminating network node, the gateway element comprising:
a first interface operable to exchange frames of packet data with the terminating network node characterizing a first user plane protocol;
a second interface operable to exchange frames of packet data with the originating network node characterizing a second user plane protocol;
means for translating between frames characterizing one of said first and second user plane protocols to the other of said first and second user plane protocols so as to initiate transcoder-free operation (TrFO).

9. The gateway element of claim 8, comprising a media gateway (MGW) residing on a terminating side of the prospective call, defining a terminating MGW.

10. The gateway element of claim 9, residing in a communication path between an originating MGW and a terminating radio network controller (RNC), the terminating RNC defining the terminating network node and the first user plane protocol comprising Iu UP version 1 protocol, the originating MGW defining the originating network node and the second user plane protocol comprising Iu UP version 2 protocol.
